(19) United States
(12) Patent Application Publication
(10) Pub. No.: US 2009/0033635 A1
(43) Pub. Date: Feb. 5, 2009

(54) Instruments, Touch Sensors for Instruments, and Methods or Making the Same

(76) Inventor: Kwong Yuen WAI, Aberdeen (HK)

Correspondence Address: RISSMAN JOBSE HENDRICKS & OLIVERIO, LLP, 100 Cambridge Street, Suite 2101, BOSTON, MA, 02114, US

(21) Appl. No.: 11/829,160

(22) Filed: Jul. 27, 2007

Related U.S. Application Data
(60) Provisional application No. 60/911,282, filed on Apr. 12, 2007.

(51) Int. Cl. G06F 3/045

(52) U.S. Cl. 345/174

(57) ABSTRACT

A touch sensor module for an instrument may comprise a touch sensor panel including a plurality of electrodes and a plurality of sensor regions on the touch sensor panel. Each sensor region has an electric field defined by the electrodes and a ground surrounding the electrodes. A processor may be configured to monitor the electric field and to determine that a sensor region of the touch sensor panel is being touched by a user when the electric field associated with that region is altered.

### CROSS-REFERENCE TO RELATED APPLICATIONS

This application claims the benefit of priority of U.S. provisional application No. 60/911,282, filed on Apr. 12, 2007, the contents of which are incorporated herein by reference in their entirety.

### TECHNICAL FIELD

The present invention is directed generally to instruments, touch sensors for instruments, and methods of making instruments. More particularly, the present invention is directed to touch sensors for timepieces and methods of making touch sensors for timepieces.

### BACKGROUND

Conventional timepieces, both analog and digital, typically have several buttons at the side or on the top of the device. These buttons may be used, for example, to change settings on the timepiece. On some conventional timepieces, buttons have been replaced with touch sensors. The use of touch sensors may provide a designer with more freedom to design the case for the timepiece. Also, since touch sensors do not include moving parts, they may facilitate water resistant design.

With some conventional touch sensor designs, electrodes are placed on the lens (e.g., glass) of the case of the timepiece for touch sensing. These conventional touch sensors are expensive and difficult to handle during assembly because it is difficult to cut the lens (e.g., glass) in different shapes with electrodes on the lens.

It may be desirable to provide a simple and economic touch sensor design. It may be desirable to provide a touch sensor that can be readily formed into different desired sizes and shapes.

### SUMMARY OF THE INVENTION

In various aspects, the present disclosure is directed to a touch sensor module for an instrument. The touch sensor module may comprise a touch sensor panel including a plurality of electrodes and a plurality of sensor regions on the touch sensor panel. Each sensor region has an electric field defined by the electrodes and a ground surrounding the electrodes. A processor may be configured to monitor the electric field and to determine that a sensor region of the touch sensor panel is being touched by a user when the electric field associated with that region is altered.

In various aspects, an instrument may comprise a touch sensor panel including a plurality of electrodes and a plurality of sensor regions on the touch sensor panel. Each sensor region has an electric field defined by the electrodes and a ground surrounding the electrodes. A processor may be configured to monitor the electric field and to determine that a sensor region of the touch sensor panel is being touched by a user when the electric field associated with that region is altered.

In some aspects, the present disclosure is directed to methods of making a touch sensor panel for an instrument. The method may comprise plating a plurality of electrodes on a touch sensor panel to define a plurality of sensor regions on the touch sensor panel. Each sensor region may have an electric field defined by the electrodes and a ground surrounding the electrodes. The method may comprise instructing a processor to monitor the electric field and instructing the processor to determine that a sensor region of the touch sensor panel is being touched by a user when the electric field associated with that region is altered.

### BRIEF DESCRIPTION OF THE DRAWINGS

FIG. 1 illustrates an exploded side view of an exemplary timepiece in accordance with various aspects of the disclosure.

FIG. 2A is a top plan view of an exemplary touch sensitive capacitor sensor in accordance with various aspects of the disclosure.

FIG. 2B is a side, cross-sectional view of an exemplary touch sensitive capacitor sensor in accordance with various aspects of the disclosure.

FIG. 3 illustrates an exploded perspective view of an exemplary touch sensor module in accordance with various aspects of the disclosure.

FIGS. 4A-4E illustrate top plan views of touch sensor panels having exemplary arrangements of sensor regions in accordance with some aspects of the disclosure.

FIG. 5 illustrates an exploded side view of an exemplary timepiece in accordance with various aspects of the disclosure.

FIG. 6A is a top plan view of an exemplary touch sensitive capacitor sensor in accordance with various aspects of the disclosure.

FIG. 6B is a side, cross-sectional view of an exemplary touch sensitive capacitor sensor in accordance with various aspects of the disclosure.

FIG. 7 illustrates an exploded perspective view of an exemplary touch sensor module in accordance with various aspects of the disclosure.

FIG. 8A-8E illustrate top plan views of touch sensor panels having exemplary arrangements of sensor regions in accordance with some aspects of the disclosure.

### DETAILED DESCRIPTION

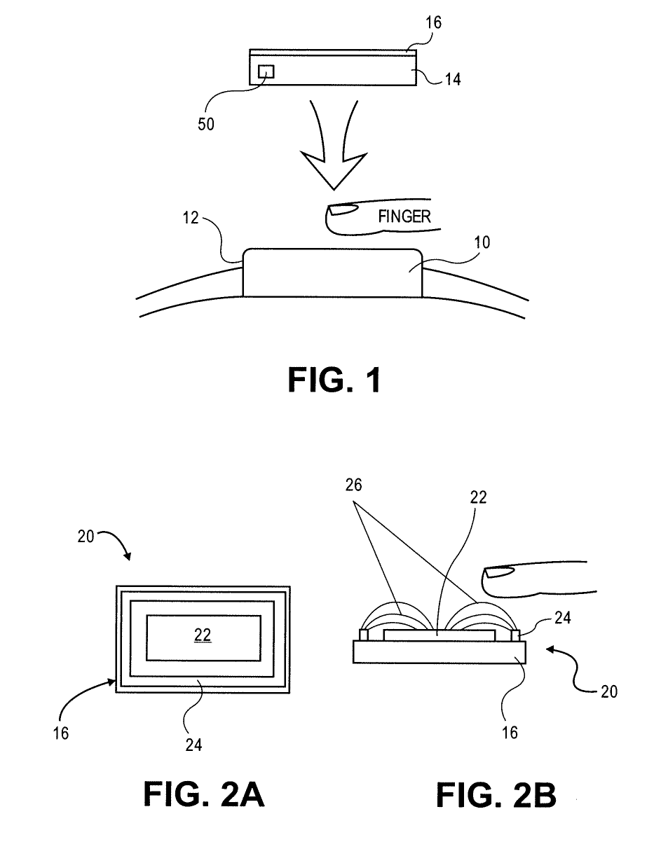

An exemplary embodiment of a timepiece 10 in accordance with various aspects of the disclosure is illustrated in FIG. 1. Although various aspects of the disclosure are directed to a timepiece, it should be appreciated that the various aspects may also pertain to other electronic devices such as, for example, wrist-worn electronic devices, handheld devices, and portable devices. These devices may include audio players, video players, monitors, or the like.

FIG. 1 shows an exploded view of the exemplary timepiece 10, which includes a case 12 and a touch sensor module 14. The touch sensor module 14 includes a touch panel 16. According to various aspects, the touch panel 16 may comprise, for example, a plastic (e.g., a transparent plastic) or a printed circuit board with electrodes. The touch panel 16 is mounted to the remainder of the touch sensor module 14 and fit into the case 12. The plastic or printed circuit board touch panel 16 can be easily formed into various desired sizes and shapes.

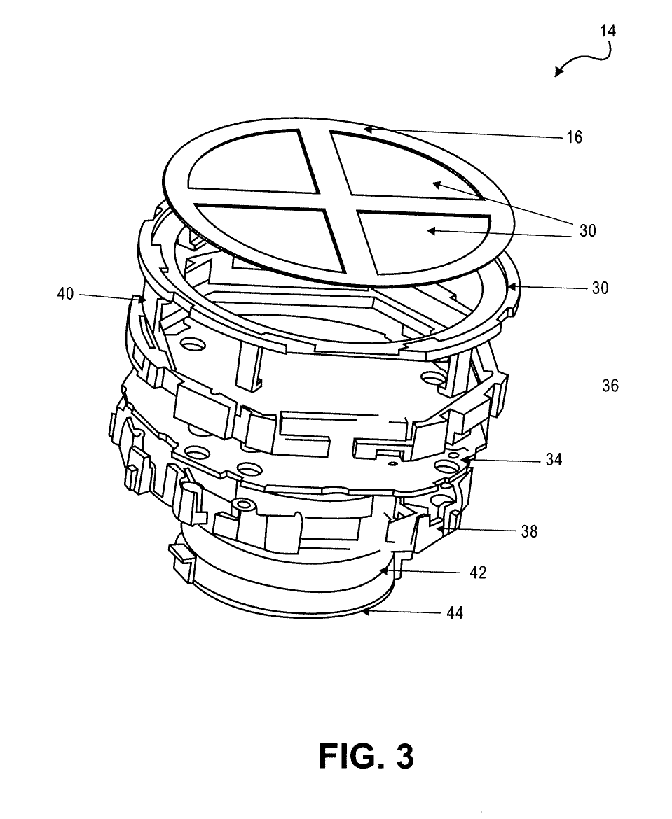

Referring to FIGS. 2A and 2B, top plan and side cross-sectional views of an exemplary touch sensitive capacitor sensor 20 in accordance with various aspects of the disclosure are illustrated. FIGS. 2A and 2B show the touch sensitive capacitor sensor 20 constructed on a printed circuit board or plastic touch sensor panel 16. The sensor 20 may include a middle sensor pad 22 surrounded by a peripheral sensor pad 24 and a ground. The ground may comprise, for example, copper traces on the printed circuit board or plastic that are connected to a negative terminal of a battery. As shown in FIG. 2B, a capacitive electric field 26 is allowed to leak into an area above the sensor pads 22, 24. When a user places a finger near an area above the capacitor sensor 20, the electric field 26 is interfered with, causing the resultant capacitance to change. The timepiece 10 may include a microcontroller (MCU) 50 (FIG. 1) instructed to monitor the changes of the capacitance of the capacitor sensor and thus to determine when the sensor 20 is touched by a finger. The microcontroller 50 may comprise any electronics circuit that can be programmed for a specific task.

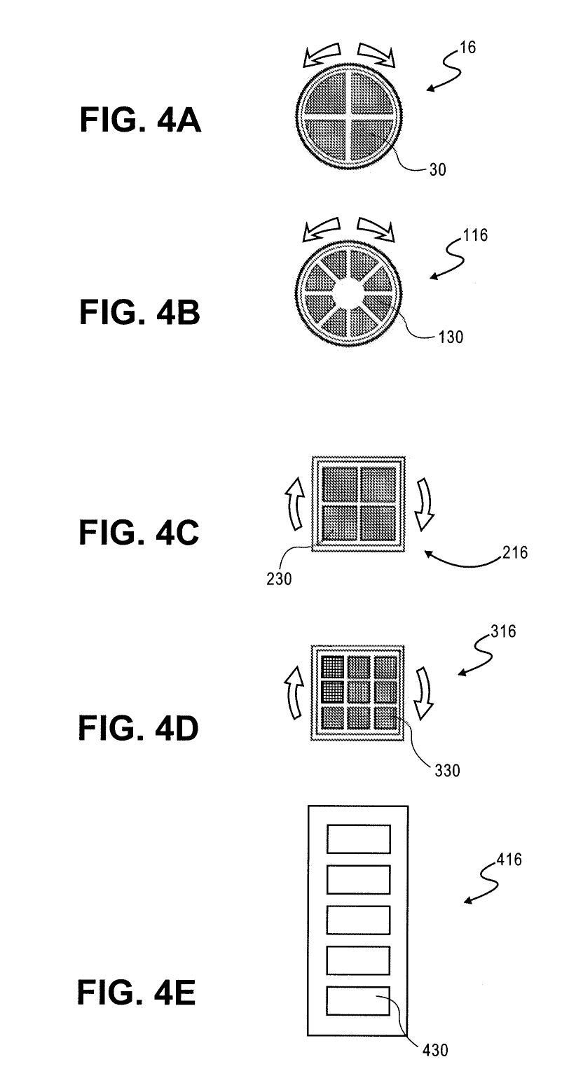

Referring now to FIG. 3, an exploded view of an exemplary touch sensor module 14 in accordance with various aspects of the disclosure is illustrated. The module 14 may include the touch sensor panel 16 as the top layer. As mentioned above, the touch sensor panel 16 may comprise, for example, a plastic or printed circuit board with electrodes plated thereon. The touch sensor panel 16 may include one or more touch sensor regions 30. Each touch sensor region 30 may comprise a touch sensitive capacitive sensor, such as, for example, sensor 20 described above.

The touch sensor panel 16 may be mounted on a touch panel holder 32. A printed circuit board 34 and a liquid crystal display (not shown), may be mounted in a housing 36, such as, for example, a plastic housing, and covered with a cover 38, such as, for example, a plastic cover. The touch panel holder 32, printed circuit board 34, housing 36, and cover 38 may be connected together via a connector 40, such as, for example, a zebra connector. The housing 36 and/or cover 38 may be configured to receive a battery 42. A battery cover 44 may be configured to cooperate with the cover 38 to contain the battery 42.

In operation, a user places a finger near an area above one or more of the touch sensor regions 30. The electric field 26 of each region where the finger is placed is interfered with, causing the resultant capacitance of that region to change. The microcontroller 50 monitors the changes of the capacitance of the touch sensor regions 30 and thus determines when one or more of the sensor regions 30 is touched by a finger. According to some aspects, the MCU 50 can be instructed to interpret a touch of each region 30 as a single button press. According to various aspects, the MCU 50 can be instructed to interpret the touch of a plurality of regions 30 as a matrix that provides a scrolling function.

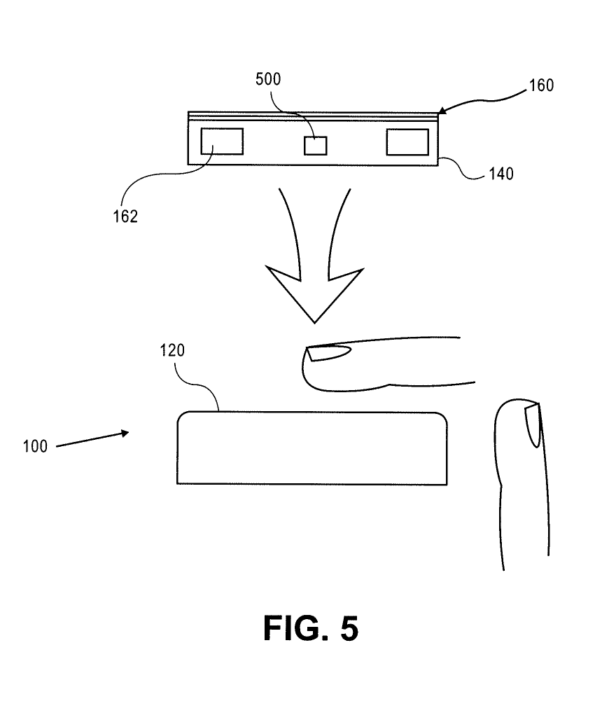

Referring now to FIGS. 4A-4E, various touch sensor panels having exemplary arrangements of sensor regions in accordance with some aspects of the disclosure are illustrated. FIG. 4A shows a substantially circular touch sensor panel 16 having four touch sensor regions 30 that may operate as four separate buttons and/or as buttons that provide clockwise and/or counterclockwise circular scrolling. FIG. 4B illustrates a substantially circular touch sensor panel 116 having eight touch sensor regions 130 that may operate as eight separate buttons and/or as buttons that provide clockwise and/or counterclockwise circular scrolling.

FIG. 4C shows a substantially square touch sensor panel 216 having four touch sensor regions 230 that may operate as four separate buttons and/or as buttons that provide clockwise and/or counterclockwise circular scrolling. FIG. 4D illustrates a substantially square touch sensor panel 316 having nine touch sensor regions 330 that may operate as nine separate buttons and/or as buttons that provide clockwise and/or counterclockwise circular scrolling. FIG. 4E shows a substantially rectangular touch sensor panel 416 having five touch sensor regions 430 that may operate as five separate buttons and/or as buttons that provide linear scrolling.

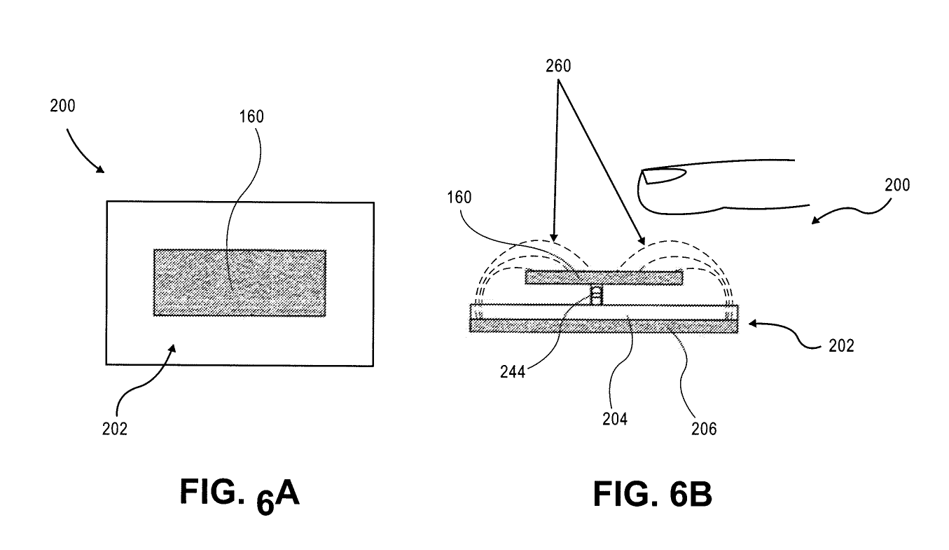

Another exemplary embodiment of a timepiece 100 in accordance with various aspects of the disclosure is illustrated in FIG. 5. Although various aspects of the disclosure are directed to a timepiece, it should be appreciated that the various aspects may also pertain to other electronic devices such as, for example, wrist-worn electronic devices, handheld devices, and portable devices. These devices may include audio players, video players, monitors, or the like.

FIG. 5 shows an exploded view of the exemplary electronics instrument 100, which includes a case 120 and a touch sensor module 140. The touch sensor module 140 includes a touch panel 160. According to various aspects, the touch panel 160 may comprise, for example, a metal foil or a printed circuit board with metal foil. The metal foil or printed circuit board with metal foil may function as electrodes. The touch panel 160 is mounted to the remainder of the touch sensor module 140 and fit into the case 120. The metal foil or printed circuit board with metal foil touch panel 160 can be easily formed into various desired sizes and shapes. According to some aspects, the touch panel 160 may include one or more side touch controls 162. The side touch control(s) 162 may comprise metal foil or printed circuit board with metal foil.

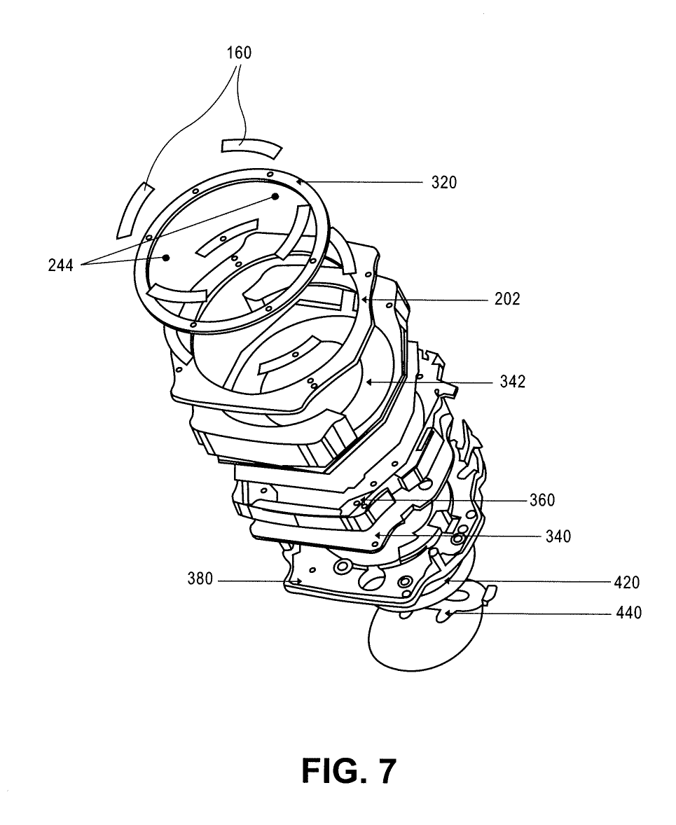

Referring to FIGS. 6A and 6B, top plan and side cross-sectional views of an exemplary touch sensitive capacitor sensor 200 in accordance with various aspects of the disclosure are illustrated. FIGS. 6A and 6B show the touch sensitive capacitor sensor 200 including a metal foil touch sensor panel 160 associated with a ground 202. The ground may comprise a printed circuit board or plastic 204 and a ground plate 206. As shown in FIG. 6B, the metal foil touch sensor panel 160 may be spaced from and coupled to the ground 202 by a metal contact or spring 244. A capacitive electric field 260 is allowed to leak into an area proximate the sensor panel 160 and ground 202. When a user places a finger near an area above the capacitor sensor 200, the electric field 260 is interfered with, causing the resultant capacitance to change. The timepiece 100 may include a microcontroller (MCU) 500 (FIG. 5) instructed to monitor the changes of the capacitance of the capacitor sensor and thus to determine when the sensor 200 is touched by a finger. The microcontroller 500 may comprise any electronics circuit that can be programmed for a specific task.

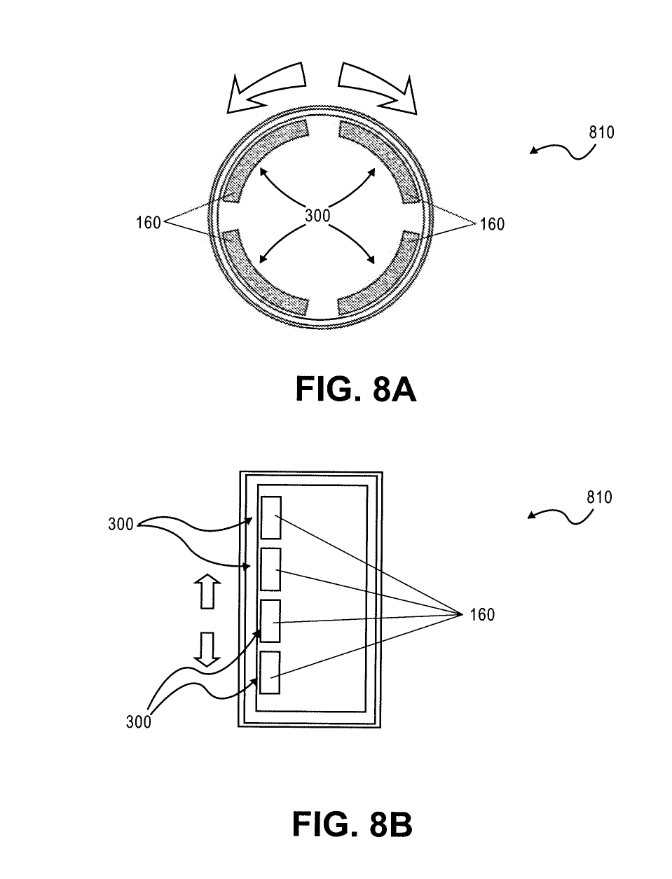

Referring now to FIG. 7, an exploded view of an exemplary touch sensor module 140 in accordance with various aspects of the disclosure is illustrated. The module 140 may include one or more touch sensor panels 160 at a top layer. As mentioned above, the touch sensor panels 160 may comprise, for example, a transparent plastic or printed circuit board with electrodes plated thereon. Each touch sensor panel 160 may define a touch sensor region 300. Each touch sensor region 300 may comprise a touch sensitive capacitive sensor, such as, for example, sensor 200 described above. Each sensor 200 may include spring or metal contact 244 and ground 202.

The touch sensor panels 160 may be mounted on a touch panel holder 320. A main printed circuit board 340 and a liquid crystal display 342 may be mounted in a housing 360, such as, for example, a plastic housing, and covered with a cover 380, such as, for example, a plastic cover. The touch panel holder 320, main printed circuit board 340, housing 360, and cover 380 may be connected together via a connector 400, such as, for example, a zebra connector. The housing 360 and/or cover 380 may be configured to receive a battery 420. A battery clip 440 may be configured to cooperate with the cover 380 to hold the battery 420.

In operation, a user places a finger near an area above one or more of the touch sensor regions 300. The electric field 260 of each region where the finger is placed is interfered with, causing the resultant capacitance of that region to change. The microcontroller 500 monitors the changes of the capacitance of the touch sensor regions 300 and thus determines when one or more of the sensor regions 300 is touched by a finger. According to some aspects, the MCU 500 can be instructed to interpret a touch of each region 300 as a single button press. According to various aspects, the MCU 500 can be instructed to interpret the touch of a plurality of regions 300 as a matrix that provides a scrolling function.

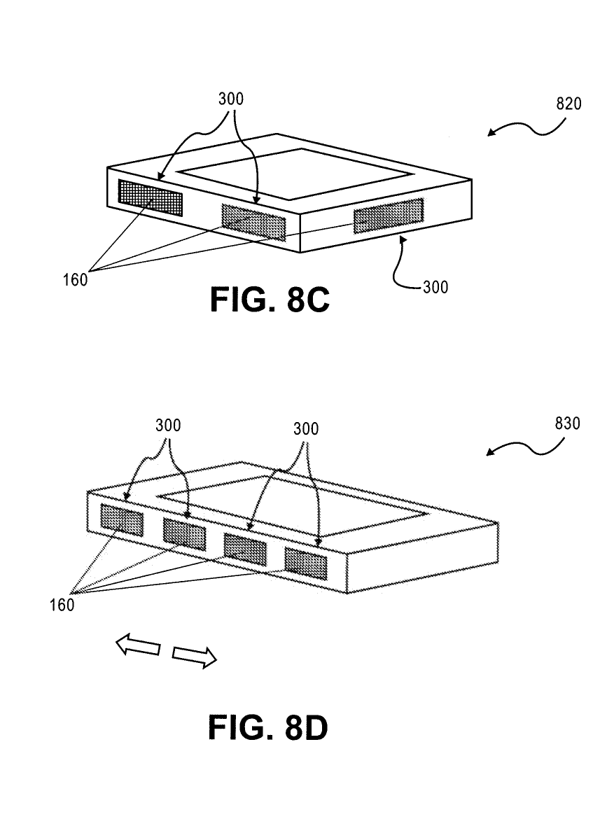

Referring now to FIGS. 8A-8D, various touch sensor panels having exemplary arrangements of sensor regions in accordance with some aspects of the disclosure are illustrated. FIG. 8A shows a substantially circularly instrument 800 having substantially circularly-arranged touch sensor panels 160 defining four touch sensor regions 300 that may operate as four separate buttons and/or as buttons that provide clockwise and/or counterclockwise circular scrolling. FIG. 8B illustrates a substantially rectangular instrument 810 having substantially linearly-arranged touch sensor panels 160 defining four touch sensor regions 300 that may operate as four separate buttons and/or as buttons that provide two-directional linear scrolling such as, for example, up-down or left-right scrolling. FIGS. 8C and 8D illustrate substantially rectangular instruments 820, 830 having side touch panels 160 defining touch sensor regions 300 that may operate as separate buttons and/or as buttons that provide two-directional linear scrolling such as, for example, up-down or left-right scrolling.

It will be apparent to those skilled in the art that various modifications and variations can be made in the instruments, touch sensors, and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A touch sensor module for an instrument, comprising:
a touch sensor panel including a plurality of electrodes;
a plurality of sensor regions on the touch sensor panel, each sensor region having an electric field defined by the electrodes and a ground surrounding the electrodes; and
a processor configured to monitor the electric field and to determine that a sensor region of the touch sensor panel is being touched by a user when the electric field associated with that region is altered.

2. The touch sensor module of claim 1, wherein the touch sensor panel comprises at least one of a metal foil, a printed circuit board, and a plastic.

3. The touch sensor module of claim 2, wherein the plastic comprises transparent plastic.

4. The touch sensor module of claim 1, wherein the touch sensor panel comprises a metal foil spaced from a printed circuit board.

5. The touch sensor module of claim 1, wherein the touch sensor panel is coupled to the printed circuit board by one of a metal contact and a spring.

6. The touch sensor module of claim 1, wherein the processor is instructed to determine that a touch of a sensor region comprises a single button press.

7. The touch sensor module of claim 1, wherein the processor is instructed to determine that touches of a plurality of sensor regions comprise a scrolling function.

8. The touch sensor module of claim 1, wherein the instrument comprises a timepiece.

9. An instrument comprising:
a touch sensor panel including a plurality of electrodes;
a plurality of sensor regions on the touch sensor panel, each sensor region having an electric field defined by the electrodes and a ground surrounding the electrodes; and
a processor configured to monitor the electric field and to determine that a sensor region of the touch sensor panel is being touched by a user when the electric field associated with that region is altered.

10. The instrument of claim 9, wherein the touch sensor panel comprises at least one of a metal foil, a printed circuit board, and a plastic.

11. The instrument of claim 10, wherein the plastic comprises transparent plastic.

12. The instrument of claim 9, wherein the touch sensor panel comprises a metal foil spaced from a printed circuit board.

13. The instrument of claim 9, wherein the touch sensor panel is coupled to the printed circuit board by one of a metal contact and a spring.

14. The instrument of claim 9, wherein the processor is instructed to determine that a touch of a sensor region comprises a single button press.

15. The instrument of claim 9, wherein the processor is instructed to determine that touches of a plurality of sensor regions comprise a scrolling function.

16. The instrument of claim 9, wherein the instrument comprises a timepiece.

17. A method of making a touch sensor panel for an instrument, the method comprising:
plating a plurality of electrodes on a touch sensor panel to define a plurality of sensor regions on the touch sensor panel, each sensor region having an electric field defined by the electrodes and a ground surrounding the electrodes;
instructing a processor to monitor the electric field; and
instructing the processor to determine that a sensor region of the touch sensor panel is being touched by a user when the electric field associated with that region is altered.

18. The method of claim 17, further comprising instructing the processor to determine that a touch of a sensor region comprises a single button press.

19. The method of claim 17, further comprising instructing the processor to determine that touches of a plurality of sensor regions comprise a scrolling function.

20. The method of claim 17, wherein the instrument comprises a timepiece.
